(19) United States
(12) Patent Application Publication
(10) Pub. No.: US 2014/0084686 A1
(43) Pub. Date: Mar. 27, 2014

(54) POWER CONVERTING APPARATUS AND NON-TRANSITORY COMPUTER READABLE MEDIUM

(71) Applicant: KABUSHIKI KAISHA TOSHIBA, Tokyo (JP)

(72) Inventors: Yasuyuki NISHIBAYASHI, Kawasaki-shi (JP); Keiichi TERAMOTO, Tokyo (JP); Kotaro ISE, Kawasaki-shi (JP)

(73) Assignee: KABUSHIKI KAISHA TOSHIBA, Tokyo (JP)

(21) Appl. No.: 13/974,336

(22) Filed: Aug. 23, 2013

(30) Foreign Application Priority Data
Sep. 24, 2012 (JP) 2012-209153

(51) Int. Cl. H02J 4/00

(52) U.S. Cl. CPC H02J 4/00
USPC 307/26

(57) ABSTRACT

In one embodiment, there is provided a power converting apparatus that includes: a power receiver configured to receive a first power from a first apparatus; a power converter configured to convert the first power into a second power; a power output module configured to output the second power to the second apparatus; a communication module configured to receive a first identifier of a main controller, wherein the main controller belongs to a first group and the main controller is configured to send a first power output instruction to at least one of the apparatuses belonging to the first group; a conversion information storage module configured to store the first identifier; and a power conversion controller configured to cause the power converter to convert the first power into the second power, when the communication module receives the first power output instruction from the main controller.

This application claims priority from Japanese Patent Application No. 2012-209153, filed on Sep. 24, 2012, the entire contents of which are hereby incorporated by reference.

### BACKGROUND

1. Technical Field

Embodiments described herein relate to a power converting apparatus and a non-transitory computer readable medium.

2. Description of the Related Art

In recent years, smart grid systems which perform power management and control using a power network and a communications network have come to be constructed in systems including a power system network (a power plant, a natural energy power plant, a battery system, and an EMS (energy management system)) and user-side systems (each includes a smart meter, a battery system, a user-side EMS (e.g., HEMS (home energy management system)). In smart grid systems, a power plant, a natural energy power plant, and a battery system can supply power to each other.

In smart grid systems, in general, a natural energy power plant and a battery system are each equipped with a power source such as a solar power generator or a battery and a power converting apparatus which is connected to the power source.

In general, the power converting apparatus is called an inverter or a converter. The power converting apparatus has a function of performing power conversion by determining input-side power and output-side power and a voltage conversion method (conversion between DC and DC, DC and AC, or AC and AC). By virtue this function of the power converting apparatus, a smart grid system as a set of power converting apparatus can switch electric energy flow rates in a smart grid system.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 shows an example whole system of a first embodiment of the present invention;

FIG. 2 shows an example battery system and EV system according to the first embodiment;

FIG. 3A shows a first example system including power converting apparatus according to the first embodiment;

FIG. 3B shows a second example system including power converting apparatus according to the first embodiment;

FIG. 4A shows example operation items that are necessary when power converting apparatus according to the first embodiment are put into practical use;

FIG. 4B shows communication messages used in the first embodiment which relate to multi-stage configuration information, charge-discharge control information, authentication information, topology information, and migration information;

FIG. 5 is a block diagram of a charge-discharge instructing apparatus according to the first embodiment;

FIG. 6 shows examples of charge-discharge specific information, charge-discharge control information, sharing permission/prohibition information, and charge-discharge-dedicated apparatus information which are used by the charge-discharge instructing apparatus according to the first embodiment;

FIG. 7 is a block diagram of a power converting apparatus according to the first embodiment;

FIG. 8 shows examples of charge-discharge specific information and charge-discharge control information which are used by the power converting apparatus according to the first embodiment;

FIG. 9 is a sequence diagram illustrating a multi-stage configuration management operation which is performed at the time of initial setting in the first embodiment;

FIG. 10 is a sequence diagram illustrating an authentication operation which is performed at the time of initial setting in the first embodiment;

FIG. 11 is a sequence diagram illustrating a topology management operation which is performed at the time of initial setting in the first embodiment;

FIG. 12 is a sequence diagram illustrating a harmonized synchronization operation which is performed at the time of initial setting in the first embodiment;

FIG. 13 is a sequence diagram illustrating a migration operation which is performed at the time of changing of operation in a second embodiment of the invention;

FIG. 14 is a sequence diagram illustrating a multi-stage configuration management operation which is performed at the time of changing of operation in the second embodiment;

FIG. 15 is a sequence diagram illustrating an authentication operation which is performed at the time of changing of operation in the second embodiment;

FIG. 16 is a sequence diagram illustrating a topology management operation which is performed at the time of changing of operation in the second embodiment; and

FIG. 17 is a flowchart showing how power converting apparatus according to the embodiments operate.

### DETAILED DESCRIPTION

According to exemplary embodiments of the present invention, there is provided a power converting apparatus. The power converting apparatus, comprises: a power receiver configured to receive a first power from a first apparatus; a power converter configured to convert the first power into a second power that can be received by a second apparatus; a power output module configured to output the second power to the second apparatus; a communication module configured to receive a first identifier of a main controller, wherein the main controller belongs to a first group which is composed of apparatuses including the power converting apparatus and the main controller is configured to send a first power output instruction to at least one of the apparatuses belonging a conversion information storage module configured to store the first identifier; and a power conversion controller configured to cause the power converter to convert the first power into the second power, when the communication module receives the first power output instruction from the main controller identified by the first identifier.

Embodiments of the present invention will be hereinafter described with reference to the drawings. The same items in the drawings are given the same reference symbol and will not be described redundantly.

### Embodiment 1

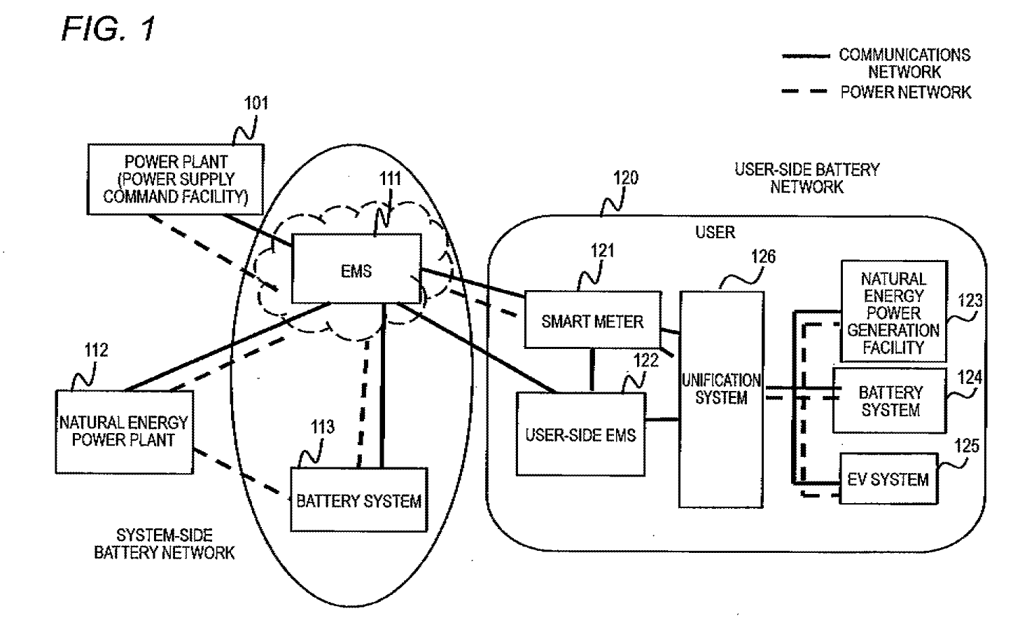

FIG. 1 shows a whole system including power converting apparatus according to a first embodiment. First, the configuration of this whole system will be described below.

In the whole system of the first embodiment, a power plant (power supply command facility) 101, an EMS (energy management system) 111, a natural energy power plant 112, and a battery system 113 are provided on a power system network. A smart meter 121, a user-side EMS 122, a natural energy power generation facility 123, a battery system 124, and an EV (electric vehicle) system 125 are provided on the side of each user 120.

The power plant (power supply command facility) 101 generates a large amount of power by thermal power generation, atomic power generation, or the like and supplies the generated power to the users 120 such as homes, buildings, and factories through power transmission and distribution networks. In the embodiment, the power transmission and distribution networks from the power plant 101 to the users 120 are generically called a power system network.

The natural energy power plant 112 generates power using naturally occurring power such as wind power or solar power and supplies the generated power to the users 120 through the power transmission and distribution networks. Installing the natural energy power plant 112 in the power system network makes it possible to reduce the load of the power plant 101 and operate it efficiently.

The battery system 113 stores surplus power generated by the power plant 101 and the natural energy power plant 112, and discharges stored power. In general, on the side of a power company, the battery system 113 is used for realizing a function called an ancillary service (short cycle control) for stabilizing the power company power system by adjusting the output in order of seconds in response to instantaneous load variations to maintain necessary quality of electricity such as the frequency and the voltage of the power company power system. On the side of the users 120 such as homes and buildings, the battery system 113 is used for realizing a function called a peak shift (daytime operation) function of storing nighttime electric energy which is low in cost and supplying it in a daytime time slot in which power demands are concentrated.

Utilizing a communications network, the EMS 111 controls the entire power system including the power supplied by each of the power plant 101 and the natural energy power generation facility 112 and the load power consumed by the users 120, to stabilize the entire power system.

The smart meter 121 measures electric energy consumed in the facilities of each user 120 and communicates the measured electric energy values to a management server of the power company on a regular basis. The management server (generally called an MDMS (metering data management system) is omitted in FIG. 1. The above-described EMS 111 cooperates with the MDMS to calculate a total amount of load power of the users 120.

The battery system 124 which is installed in the facilities of each user 120 stores electric energy that is supplied from the power company power system network or electric energy that is generated by the natural energy power generation facility 123 which is installed in the facilities of the user 120.

The EV system 125 stores electric energy in the battery provided therein via a charger 250 (described later).

The natural energy power generation facility 123 which is installed in the facilities of the user 120 generates power using naturally occurring power such as wind power or solar power.

A aggregation module 126 converts power that is input, via the transmission and distribution networks, from a system outside the user 120 such as a power system (e.g., power plant 101) into power that can be input to a destination apparatus or system such as the natural energy power generation facility 123, the battery system 124, or the EV system 125. Furthermore, the aggregation module 126 converts power that is input from the natural energy power generation facility 123, the battery system 124, and the EV system 125 and outputs resulting power to a system outside the user 120 such as a power system.

The user-side EMS 122 adjusts and controls the power consumption of the user 120. Where the user 120 is a home, a HEMS adjusts and controls the power consumption of the home. Where the user 120 is a building, a BEMS adjusts and controls the power consumption of the building. Where the user 120 is a factory, a FEMS (factory management system) adjusts and controls the power consumption of the factory.

The power converting apparatus according to the embodiment is provided in each of the natural energy power plant 112, the battery system 113, the natural energy power generation facility 123, the battery system 124, the EV system 125, and the aggregation module 126. A detailed configuration of the power converting apparatus will be described later. The description of the configuration of the entire system ends here.

Next, system configurations relating to the power converting apparatus according to the embodiment will be described below in detail.

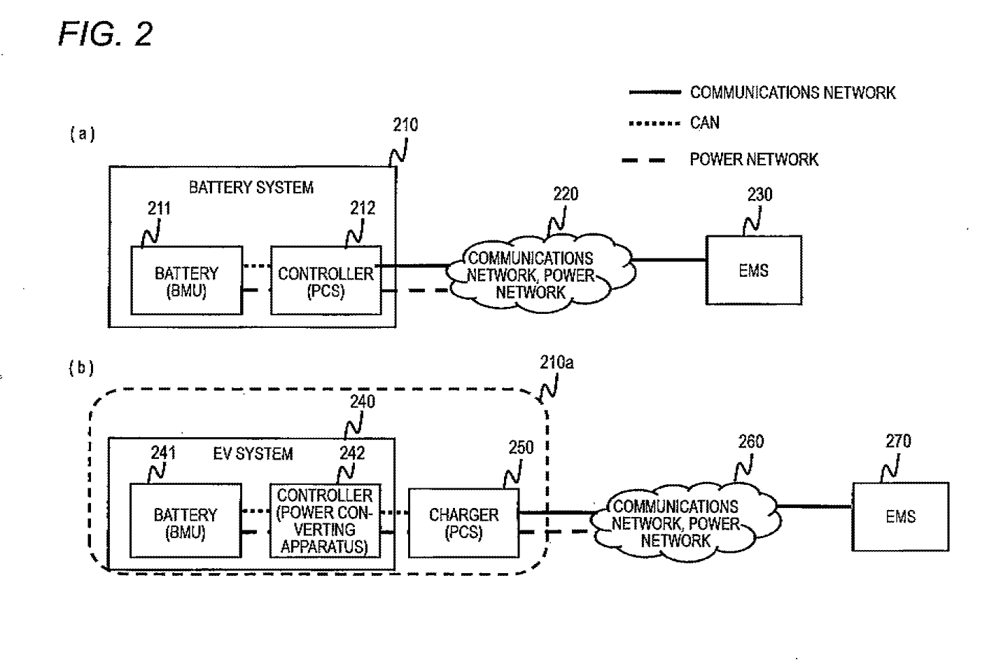

FIG. 2 shows the configurations of a battery system 210 and an EV system 240 according to the first embodiment. The battery system 210 shown in FIG. 2(a) corresponds to each of the battery systems 113 and 124 shown in FIG. 1, and the EV system 240 shown in FIG. 2(b) corresponds to the EV system 125 shown in FIG. 1. It is assumed that the battery system 210 is mainly used as a stationary system and the EV system 240 is mainly used as a vehicular system.

The battery system 210 and the EV system 240 shown in FIG. 2 are each equipped with a battery (BMU: battery management unit). Alternatively, a natural energy power generator (wind power, solar power, or the like) may be used instead of the battery. Such a system corresponds to the natural energy power plant 112 or the natural energy power generation facility 123.

The battery system 210 is equipped with a battery (BMU) 211 and a controller (power converting apparatus) 212.

The battery 211 is equipped with plural battery cells and an internal processor for managing the internal state of a battery pack. The battery 211 charges or discharges power according to an instruction from the controller 212. The battery 211 informs the controller 212 of its rated voltage, charge-discharge maximum currents, state of charge (SOC), and state of health (SOH).

The controller 212 also has power converting apparatus functions, and also called an inverter, a converter, or a PCS (power conditioning system). The controller 212 performs, as power converting apparatus functions, determination of input/output power values, determination of voltages, DC/AC conversion, and suppression of voltage variation.

With a communication function, the controller 212 communicates with an EMS 230 (corresponds to the EMS 111 shown in FIG. 1) which is installed in the power system network. The controller 212 communicates such information as an SOC and an SOFT of the battery 211 to the EMS 230. In general, self-discharge occurs in batteries. Collecting such information as an SOC and an SOH of the battery 211 from the battery system 210, the EMS 230 can properly monitor the state of the battery 211 which varies every moment and give charge-discharge control instructions to the battery system 210.

In the embodiment, the whole of various kinds of power input and output that are done through the controller 212 is considered charge-discharge control. That is, various kinds of power including, in addition to power relating to the battery 211, natural power such as wind power and solar power and power that is exchanged with the power system network are input and output through the controller 212. In each power system which is a set of power converting apparatus, each power converting apparatus switches the input or output power. The controller 212 may be implemented on an external processor that is connected to the battery system 210.

The battery (BMU) 211 and the controller (power converting apparatus) 212 are connected to each other by a CAN (controller area network). The charge-discharge control and the information notification which are done between the battery 211 and the controller 212 are realized using the CAN. Instead of the CAN, a wired communication medium such as an Ethernet(R), a wireless communication medium such as a LAN (local area network), or an electric signal line that is defined independently by a vendor of a product.

The EV system 240 is similar in configuration to the battery system 210, and is different from the latter in that part of the functions of the controller 212 of the battery system 210 are transferred to an external charger 250 which is connected to the EV system 240. That is, when connected to the charger 250, the EV system 240 serves as a battery system 210a which corresponds to the battery system 210.

A controller 242 of the EV system 240 relays a charging control and information notification between a battery (BMU) 241 and the charger (power converting apparatus) 250. In the configuration shown in FIG. 2(b), two power converting apparatus are provided in the controller 242 and the charger 250, respectively. For example, the two power converting apparatus may perform different functions in such a manner that the power converting apparatus that is connected to the power system network (i.e., the power converting apparatus provided in the charger 250) performs DC/AC conversion and the power converting apparatus that is connected to the internal battery 241 or a natural energy power generation facility (i.e., the power converting apparatus provided in the controller 242) performs DC/DC conversion. The controller 242 of the EV system 240 may be given the same functions as the controller 212 of the battery system 210. Pieces of algorithm-based processing relating to charging and discharge of the battery 241 may be performed in any of plural forms; for example, they may be performed in a concentrated manner by any of the controller 242, the charger 250, the user-side EMS 270, the EMS of the power system network, etc.

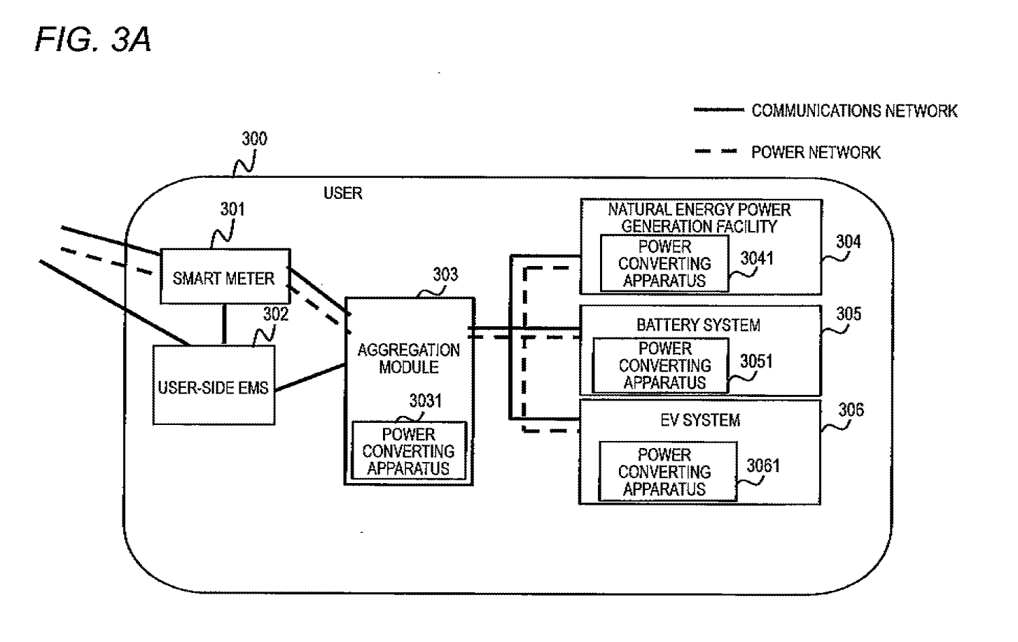

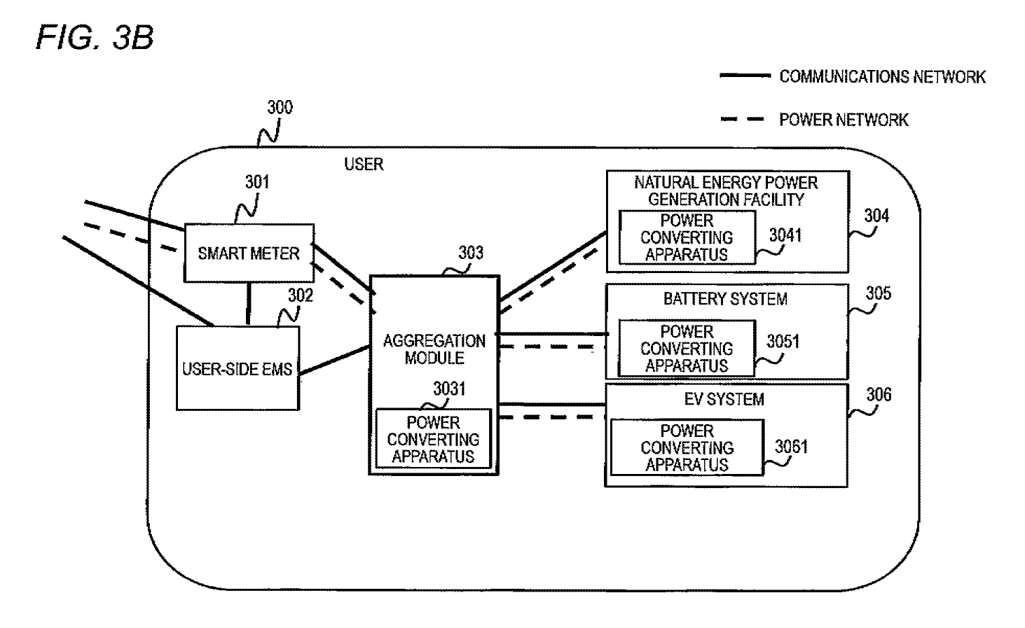

Next, a user-side system configuration relating to the power converting apparatus according to the embodiment will be described in detail with reference to FIG. 3A. FIG. 3A shows a user-side system configuration which is part of the configuration of the whole system shown in FIG. 1. Although the following description will be directed to the user-side system, the following concept of the embodiment can also be applied to non-user-side systems.

The user-side system shown in FIG. 3A is equipped with a smart meter 301, a user-side EMS 302, a aggregation module 303, a natural energy power generation facility 304, a battery system 305, and an EV system 306, which correspond to the smart meter 121, the user-side EMS 122, the aggregation module 126, the natural energy power generation facility 123, the battery system 124, and the EV system shown in FIG. 1, respectively. The smart meter 301, the user-side EMS 302, and the aggregation module 303 can communicate with each other. And the aggregation module 303, the natural energy power generation facility 304, the battery system 305, and the EV system 306 can communicate with each other. The smart meter 301 is electrically connected to the aggregation module 303, and the natural energy power generation facility 304, the battery system 305, and the EV system 306 which are electrically connected to each other are also electrically connected to the aggregation module 303. Input/output of power is possible between the blocks that are electrically connected to each other.

In the system of FIG. 3A, the aggregation module 303, the natural energy power generation facility 304, the battery system 305, and the EV system 306 are equipped with power converting apparatus 3031, 3041, 3051, and 3061, respectively, each of which corresponds to a power converting apparatus 700 (described later).

Each of the power converting apparatus 3031, 3041, 3051, and 3061 shown in FIG. 3A also correspond to the controller 212 shown in FIG. 2. In specific implementations, each of the power converting apparatus 3031, 3041, 3051, and 3061 is called an inverter, a converter, or a PCS. Each of the power converting apparatus 3031, 3041, 3051, and 3061 determines power values of an input source and an output destination and voltages (DC/DC, DC/AC, or AC/AC).

In the embodiment, the term “power converting apparatus” means a system including the controller 212 or 242 shown in FIG. 2 (as in the case of the battery system 305, the EV system 306, or the like) or the controller 212 or 242 itself.

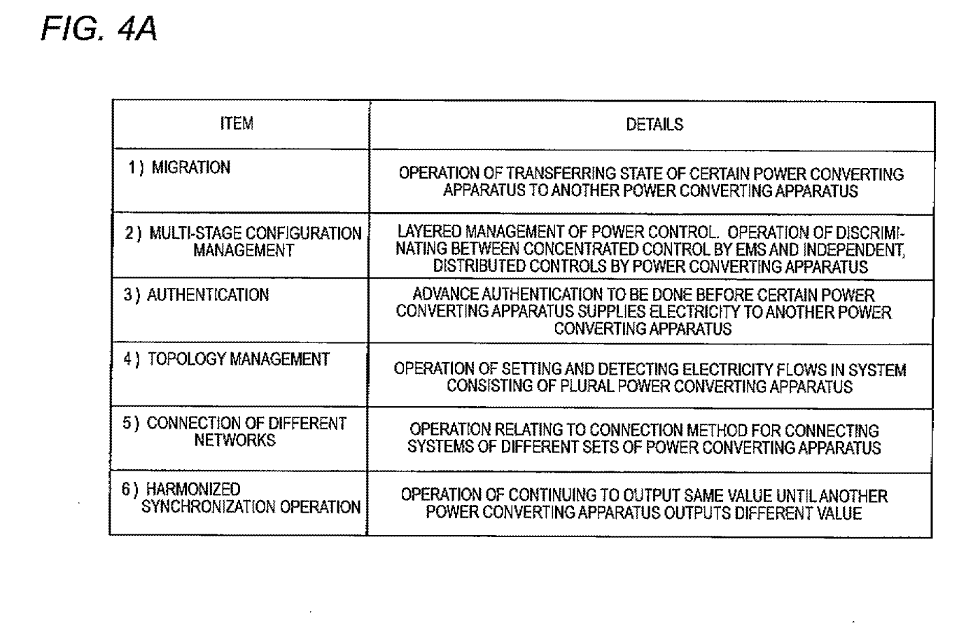

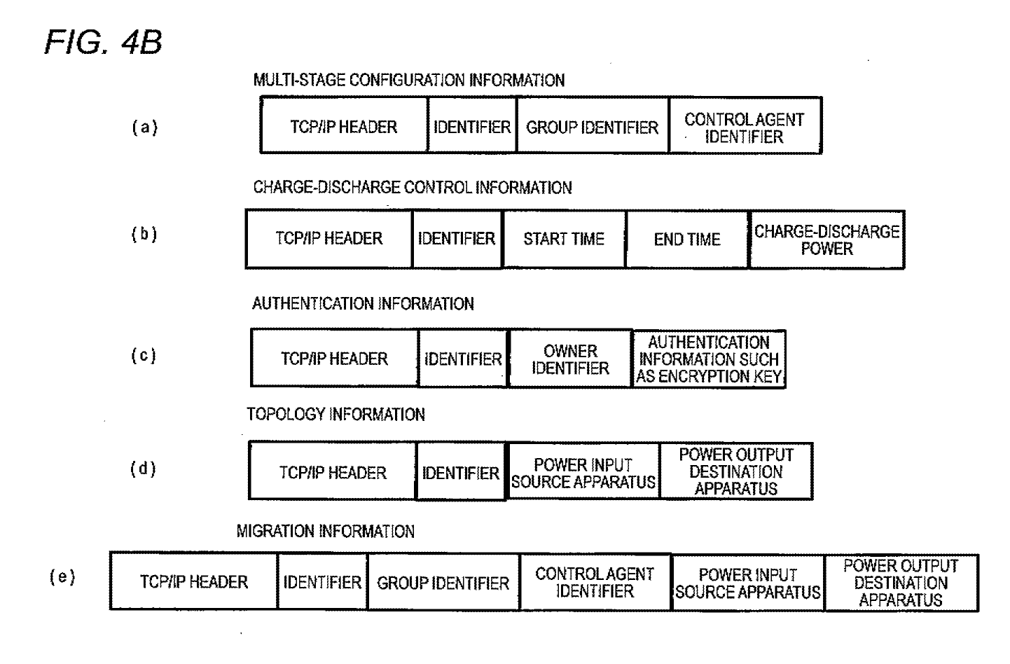

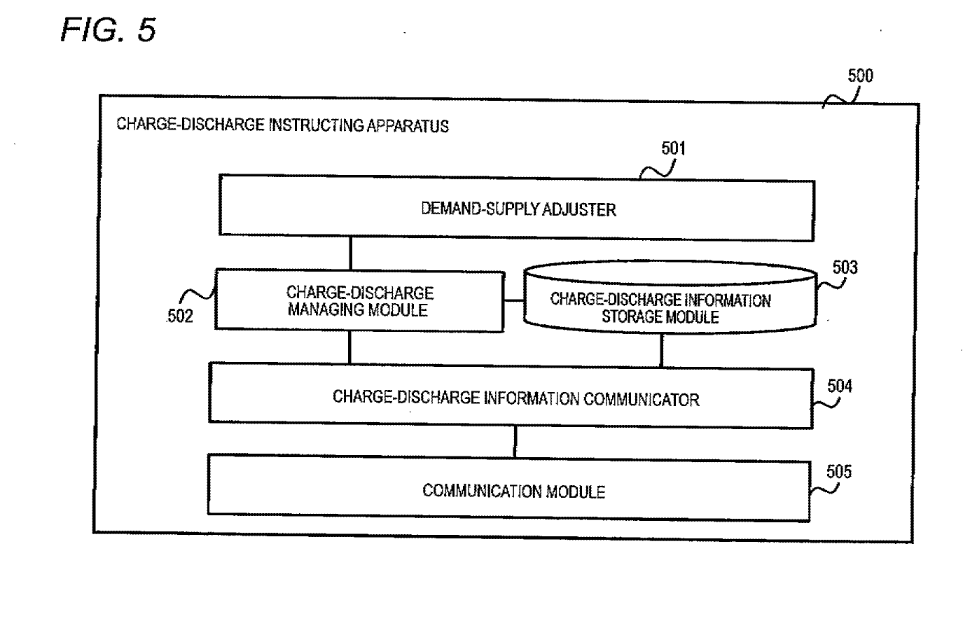

For example, the user-side system shown in FIG. 3A operates in such a manner that whereas each of the power converting apparatus 3041, 3051, and 3061 provided in the natural energy power generation facility 304, the battery system 305, and the EV system 306, respectively, performs DC/DC conversion, the power converting apparatus 3031 of the aggregation module 303 which may be connected to the power system network performs DC/AC conversion. The power converting apparatus 3031 of the aggregation module 303 has a role of managing electric energy flow rates. There were two methods by which the power converting apparatus 3031 plays this role. In the first method, the power converting apparatus 3031 is controlled by the user-side EMS 302 in a concentrated manner. In the second method, the power converting apparatus 3031 exchanges communication messages independently in a distributed manner with the power converting apparatus 3041, 3051, and 3061 provided in the natural energy power generation facility 304, the battery system 305, and the EV system 306, respectively. How the user-side EMS 302 operates in the latter method will be described later in detail with reference to FIG. 5. It is assumed that each of the power converting apparatus 3041, 3051, and 3061 has part of the functions of the user-side EMS 302 as well as functions specific to it that are performed when it operates independently in a distributed manner (see FIG. 4A).

A system shown in FIG. 3B is different from the system of FIG. 3A in the manner of connections of the communications network and the power network between the aggregation module 303 and the combination of the natural energy power generation facility 304, the battery system 305, and the EV system 306. In the system shown in FIG. 3A, a single communications line and a single power line are shared by the aggregation module 303 and the combination of the natural energy power generation facility 304, the battery system 305, and the EV system 306. On the other hand, in the system of FIG. 3B, the aggregation module 303 is connected to the natural energy power generation facility 304, the battery system 305, and the EV system 306 by separate communications lines and separate power lines.

Where a power system has no EMS to serve as a main control apparatus, several operation items as shown in FIG. 4A are necessary to allow power converting apparatus to cooperate collectively. The example of FIG. 4A includes six operation items which are migration, multi-stage configuration management, authentication, topology management, connection of different networks, and harmonized synchronization operation.

FIGS. 4B(a)-4B(e) show communication messages which are exchanged between apparatus in the first embodiment. More specifically, FIGS. 4B(a)-4B(e) show communication messages relating to multi-stage configuration information, charge-discharge control information, authentication information, topology information, and migration information, respectively.

Each communication message has an identifier for identification of message contents in addition to a TCP/IP (transmission control protocol/Internet protocol) communication header. Examples of specific methods for constructing such communication messages are to follow the procedure of an international standard such as IEC 61850 which prescribes a communication specification relating to distribution type power sources and to follow the procedure of a Web service using XML (extensible markup language). However, in the embodiment, such communication messages can be constructed freely according to application sites instead of relying on a particular protocol. The contents of communication messages are not limited to those shown in FIGS. 4B(a)-4B(e) and, if necessary, may be adapted as appropriate according to specifications of a related standard etc.

The migration shown in FIG. 4A is an operation of transferring a state of a certain power converting apparatus to another power converting apparatus. For example, if occurrence of a failure or an abnormality is detected in the aggregation module 303 while it is acting as a main control apparatus in place of the user-side EMS 302 (see FIGS. 3A and 3B), the status information being managed by the aggregation module 303 is transferred to another power converting apparatus (in the examples of FIGS. 3A and 3B, one of the power converting apparatus 3041, 3051, and 3061 provided in the natural energy power generation facility 304, the battery system 305, and the EV system 306, respectively). In the migration, an apparatus as an original main control apparatus communicates migration information to an apparatus to become a new main control apparatus. An example communication message relating to migration information is shown in FIG. 4B(e). For example, a communication message relating to migration information contains a control agent identifier for identification of a new control agent apparatus of a group which is a set of power converting apparatus and a group identifier for identification of the control subject group. When receiving the control agent identifier, the apparatus to become a new main control apparatus can judges that it will be made a new main control apparatus of the group. The migration information also includes information relating to topology management information (described later).

The multi-stage configuration management is an operation of discriminating between a concentrated control by a user-side EMS and independent, distributed controls by power converting apparatus in layered management of power control. This serves to prevent a control right contention by recognizing a main control apparatus of the system through exchange of communication messages in installing a new distribution-type power source or aggregation module which is equipped with a power converting apparatus. An example communication message relating to multi-stage configuration information is shown in FIG. 4B(a). For example, in constructing a new group which is a set of a main control apparatus and power converting apparatus to be controlled by the main control apparatus, an apparatus to become the main control apparatus communicates a communication message relating to multi-stage configuration information to the power converting apparatus in the group. For example, this is done in performing initial setting on a group or changing a main control apparatus. For example, as shown in FIG. 4B(a), a communication message relating to multi-stage configuration information contains a group identifier for identification of a group and a control agent identifier for identification of a main control apparatus. Each power converting apparatus belonging to the group can recognize the control main apparatus by receiving this message. For example, each power converting apparatus performs charging or discharge when receiving a charge-discharge instruction message from the main control apparatus, and does not perform charging or discharge when receiving a charge-discharge instruction message from an power converting apparatus that is not recognized as the main control apparatus.

The authentication is advance authentication to be done before a certain power converting apparatus supplies electricity to another power converting apparatus. For example, when an electric vehicle incorporating a power converting apparatus is to be supplied with power from a home, illegal use of power is prevented by confirming that the power converting apparatus is owned by a legitimate person through authentication. An example communication message relating to authentication information is shown in FIG. 4B(c). For example, an apparatus that requests supply of power communicates, to an apparatus capable of supplying power, an owner identifier for identification of the requesting apparatus. The apparatus capable of supplying power has, in advance, a list of supply destinations to which it is allowed to supply power. Receiving a communication message relating to authentication information, the apparatus capable of supplying power can judge whether or not it is allowed to supply power to the requesting apparatus by comparing the apparatus of the owner identifier contained in the message with the list. An apparatus that requests supply of power may communicate a communication message relating to authentication information to a main control apparatus of a group of power converting apparatus. The main control apparatus has, in advance, a list of apparatus that should be allowed to join the group. Receiving the communication message relating to authentication information, the main control apparatus can judge whether or not the requesting apparatus is eligible to join the group by comparing the apparatus of the owner identifier contained in the message with the list. The main control apparatus performs a charge-discharge control on the requesting apparatus if it judges that the apparatus of the owner identifier contained in the communication message relating to authentication information is eligible to join the group.

The topology management is an operation of setting and detecting electricity flows in a system consisting of plural power converting apparatus. For example, in the system of FIG. 3A, cost reduction can be attained in the case where power values are correlated with prices etc. and the system can be made redundant by making and detecting a logical setting as to whether power for charging the battery system 305 should be supplied from the power system network via the aggregation module 303 or supplied from the natural energy power generation facility 304.

Examples of topology management will be described using the systems shown in FIGS. 3A and 3B. Topology management methods are different in the systems of FIGS. 3A and 3B because they are different in the manner of connections of the power network. In the system of FIG. 3A, the single power line is shared by the aggregation module 303 and the combination of the natural energy power generation facility 304, the battery system 305, and the EV system 306. On the other hand, in the system of FIG. 3B, the aggregation module 303 is connected to the natural energy power generation facility 304, the battery system 305, and the EV system 306 by the separate power lines. Therefore, in the system of FIG. 3A, there are two kinds of settings for the output destinations of the topology management, that is, “output should be made to all of the natural energy power generation facility 304, the battery system 305, and the EV system 306” and “output should be made to none of the natural energy power generation facility 304, the battery system 305, and the EV system 306.” For example, if there exists just one unreliable apparatus, output is not made to none of them. On the other hand, in the system of FIG. 3B, whether output of power is appropriate or not can be determined for each of the natural energy power generation facility 304, the battery system 305, and the EV system 306.

An example communication message relating to topology information is shown in FIG. 4B(d), which contains a power input source apparatus and a power output destination apparatus.

The connection of different networks is an operation relating to a connection method for connecting systems of different sets of power converting apparatus. In the example of FIG. 3A, assume that the power system formed in the user 300 by the four power converting apparatus 3031, 3041, 3051, and 3061 of the aggregation module 303, the natural energy power generation facility 304, the battery system 305, and the EV system 306 is a first power system and the power-system-network-side power system which is connected to the user 300 through the aggregation module 303 is a second power system. For example, an application would be possible in which the sum of input/output power values of the first power system is communicated to the second power system and user-300-side power is used on the power system network side. In connecting different networks, it is one option to inform various kinds of information shown in FIGS. 4B(a)-4B(d).

The harmonized synchronization operation is an operation of attaining harmonization by continuing to output the same value until another power converting apparatus outputs a different value. When a new distribution type power source incorporating a power converting apparatus has been installed, the harmonized synchronization operation is used for, for example, a purpose of suppressing a variation by adapting to a power characteristic that is output from another apparatus in the power system in which the power converting apparatus has been installed on the basis of a communication message acquired over a communications network or electric monitoring information whereas immediately after activation power conversion is performed at a preset voltage, frequency, etc.

On the power system network side, in general, a battery system has a function called an ancillary service to cope with an instantaneous load variation. In this case, since it is necessary to secure a large electricity storage capacity that is equivalent to a capacity of a power plant, it is desirable to install plural distribution type power sources each incorporating a power converting apparatus. Where a power user belongs to plural networks, power storage and power supply occur simultaneously. Therefore, a system form may be employed in which plural main control apparatus and plural apparatus to be controlled exist in mixture. On the other hand, in general, a user side as a function called peak shifting in less expensive nighttime electric energy is stored and used in a daytime time slot in which power demands are concentrated. In addition, an operation form may be employed in which a power company performs a charge-discharge control on a distribution type power source system that is installed on the user side on condition that the user side is given a certain incentive. Therefore, also on the user side, a system form may be employed in which plural main control apparatus and plural apparatus to be controlled exist in mixture. To maintain safety and a necessary power throughput and solve a communication bandwidth shortage and other problems, it is desirable that power converting apparatus perform a proper combination from the operation items shown in FIG. 4A.

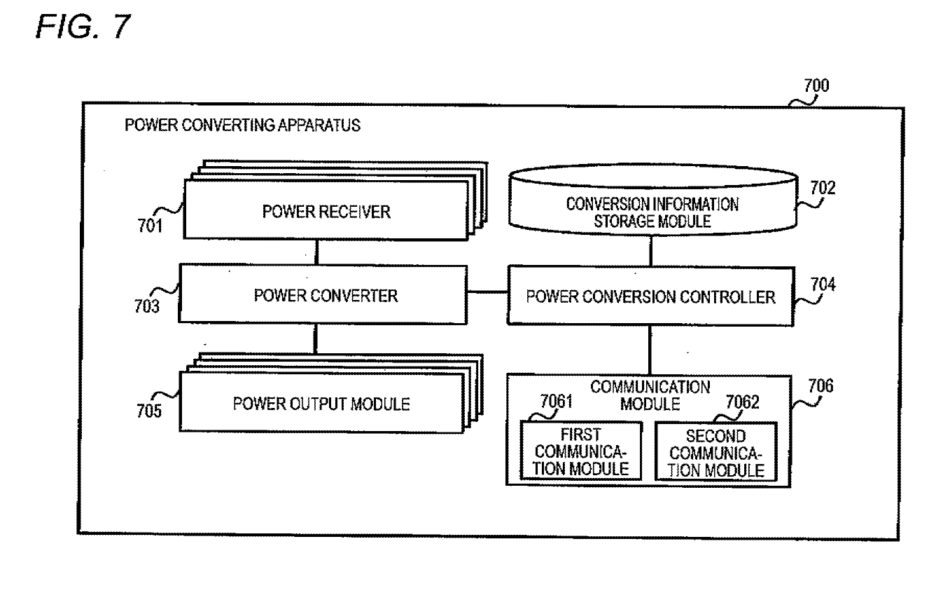

FIG. 5 is a block diagram showing the configuration of a charge-discharge instructing apparatus 500 according to the first embodiment. In the system of FIG. 1, the EMS 11 in the power system network or the user-side EMS 122 which is installed in the facilities of the user 120 has the functions of the charge-discharge instructing apparatus 500. Where power converting apparatus according to the embodiment perform independent, distributed operations, each of them (a power conversion controller 704 of a power converting apparatus 700 shown in FIG. 7 (described later)) bears part of the functions of the charge-discharge instructing apparatus 500.

The charge-discharge instructing apparatus 500 is equipped with a demand-supply adjuster 501, a charge-discharge managing module 502, a charge-discharge information storage module 503, a charge-discharge information communicator 504, and a communication module 505.

The demand-supply adjuster 501 monitors a power supply amount and a frequency state in the power system network of a power company or user facilities. Furthermore, the demand-supply adjuster 501 judges whether or not it is necessary to, for example, give a discharge control instruction to a battery system or a natural energy power plant or generation facility of wind power, solar power, or the like to prevent a blackout due to a power supply shortage or to give a charging control instruction to a battery system for later use of surplus power that results from excessive supply of power, and gives such an instruction as appropriate. The demand-supply adjuster 501 has a role of an application processing unit.

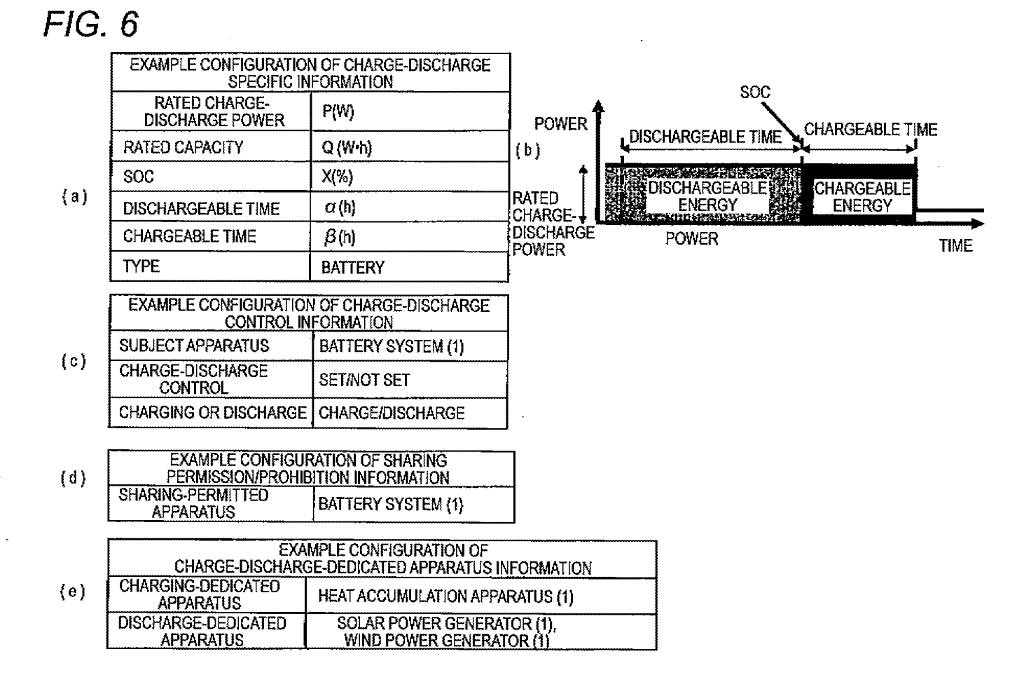

In the embodiment, the charge-discharge information storage module 503 stores information that is necessary when the natural energy power plant or the battery system performs a charge-discharge control. More specifically, the charge-discharge information storage module 503 stores charge-discharge specific information, charge-discharge control information, sharing permission/prohibition information, and charge-discharge-dedicated apparatus information. FIGS. 6(a)-6(e) show example configurations of charge-discharge specific information, charge-discharge control information, sharing permission/prohibition information, and charge-discharge-dedicated apparatus information, respectively.

The charge-discharge specific information shown in FIG. 6(a) is pieces of information that are specific to a natural energy power generator or a battery and are necessary for a charge-discharge control. In the example of FIG. 6(a), the charge-discharge specific information includes rated charge-discharge power (W), a rated capacity (W·h), a state of charge (SOC; %), and a dischargeable time and a chargeable time which are correlated with the SOC. The SOC is information that is specific to the battery, and can be omitted in the case of charge-discharge specific information relating to the natural energy power generator. In the case of the constant current charging method which is a common charging method of batteries, the input/output power (current) of the battery cells of a battery unit (BMU) is kept constant until the SOC (%) reaches a prescribed threshold value. Therefore, as shown in a graph of FIG. 6(b), by acquiring an SOC value from the battery system, the charge-discharge instructing apparatus 500 can calculate a corresponding chargeable time and dischargeable time (on the horizontal axis of the graph), a maximum charge-discharge power (vertical axis of the graph), electric energy values necessary for charging and discharge (products of the power and the chargeable time and the dischargeable time). The constant current charging method has a feature that the current that is necessary for charging is minimized after the SOC has exceeded the prescribed threshold value. In charge-discharge controls, another parameter “current hour” (A·h) or “voltage hour” (V·h) may be used instead of the parameter “electric energy” (W·h).

The charge-discharge control information shown in FIG. 6(c) is used for recognizing a charge-discharge operation state of the natural energy power plant or generation facility or the battery system. For example, when the battery system is to be controlled in real time to prevent an instantaneous power failure in a power network, it is desirable that the charge-discharge instructing apparatus 500 perform an on-demand operation in which it sends or receives a communication message relating to a charge-discharge control instruction when necessary. On the other hand, when controls are to be performed at relatively long intervals in a nighttime time slot, it is desirable that the charge-discharge instructing apparatus 500 perform a planned operation according to a schedule of a charge-discharge control operation. In an item “charge-discharge control” of the charge-discharge control information shown in FIG. 6(c), “set/not set” indicates whether schedule information for a planned operation is set or not set.

The sharing permission/prohibition information shown in FIG. 6(d) is used for recognizing an apparatus capable of receiving charge-discharge controls from plural EMSs (or power converting apparatus). In the example of FIG. 6(d), an item “sharing permitted apparatus” has information indicating an apparatus that is permitted to be shared. For expel, the sharing permission/prohibition information is used in the case where the battery system is used in a time-divisional manner or subjected to simultaneous charge-discharge controls under the control of plural main control apparatus.

The charge-discharge dedicated apparatus information shown in FIG. 6(e) means that the charge-discharge instructing apparatus 500 is not dedicated to the battery system and can also be used for control of discharge-dedicated apparatus such as a solar power generator and a wind power generator and a charging-dedicated apparatus such as a heat accumulation apparatus.

The pieces of information shown in FIGS. 6(a) and 6(c)-6(e) which are stored in the charge-discharge information storage module 503 can be changed if necessary according to an application site; for example, only part of these pieces of information may be used and information of a communication protocol type to be used for authentication may be added. If necessary, these pieces of information are stored in a conversion information storage module 702 of a power converting apparatus 700 (described later).

The charge-discharge managing module 502 gives charge-discharge control instructions to distribution type power sources provided in a natural energy power plant or generation facility or a battery system, and specifies input/output power values of power converting apparatus provided in distribution type power sources. To describe an example of management of total charge-discharge power, assume that there are two battery systems, that is, battery system-1 and battery system-2. If battery system-1 discharges at power 100 W and battery system-2 discharges at power 200 W in a time interval t1, the total discharge power in this time interval is equal to 300 W. Recognize, as a group, plural power converting apparatus provided in distribution type power sources, the charge-discharge instructing apparatus 500 can issue charge-discharge control instructions for the respective groups while monitoring a demand-supply adjustment state. A charge-discharge control instruction is given to an apparatus that performs an on-demand type operation in the form of a specified charge-discharge power value, and to an apparatus that performs a planned operation in the form of a specified charge-discharge power value and time interval.

To send such a control instruction as a communication message through the communication module 505, the charge-discharge information communicator 504 may employ, for respective application sites, different data models/communication protocols such as IEC 61850 which is a power infrastructure standard for control of distribution type power sources, BACnet which is a standard for buildings, ECHONET for Japanese homes, and ZigBee SEP (smart energy profile) 2 for European holes so that a charge-discharge control is performed according to specifications of each standard. However, in the embodiment, naturally, different data models/communication protocols may be employed freely without being restricted by specification items of a particular protocol. Communication messages will be described later in detail.

The communication module 505 can be realized by using a wired communication medium such as an optical fiber, a telephone line, or an Ethernet(R) or a wireless communication medium. However, in the embodiment, the communication module 505 does not rely on a particular communication medium. Safety can be enhanced by using an authentication procedure. However, in the embodiment, the authentication procedure is not limited to a particular form.

FIG. 7 is a block diagram showing an example configuration of a power converting apparatus 700 according to the first embodiment. The power converting apparatus 700 corresponds to the controller 212 of the battery system 210 shown in FIG. 2(a) and the charger 250 and the controller 242 of the EV system 240 shown in FIG. 2(b). Where a controller is connected to a natural energy power generator (wind power or solar power) of a natural energy power plant or generation facility, the controller corresponds to the power converting apparatus 700. For example, the power converting apparatus 700 may be, rather than the controller 212 itself of the battery system 210, an external controller which has a communication processing unit and hence can communicate with an EMS or another power converting apparatus.

As shown in FIG. 7, the power converting apparatus 700 is equipped with power receivers 701, a power converter 703, power output modules 705, a conversion information storage module 702, a power conversion controller 704, and a communication module 706. The power receivers 701, the power converter 703, and the power output modules 705 may be combined together to constitute a power supply module.

Each power receiver 701 receives power from another apparatus (input source apparatus) which is, for example, another power converting apparatus or a power source (battery, natural energy power generator, or the like).

The power converter 703 converts the received power into power that can be received by an output destination apparatus. More specifically, the power converter 703 performs DC/AC or DC/DC conversion, power frequency monitoring, detection and suppression of a voltage variation, etc. And the power converter 703 performs a charge-discharge control on a natural energy power generator or a battery according to an instruction message transmitted from an EMS or another power converting apparatus. In the embodiment, a charge-discharge control can likewise be performed using another parameter “current hour” (A·h) or “voltage hour” (V·h) instead of the parameter “electric energy” (W·h).

Each power output module 705 outputs the converted power of the power converter 703 to an output destination apparatus which is, for example, another power converting apparatus or a power source (battery, natural energy power generator, or the like).

In the embodiment, the conversion information storage module 702 stores information that is necessary to give an instruction to the power converter 703. More specifically, the conversion information storage module 702 stores, in addition to charge-discharge specific information, charge-discharge control information, sharing permission/prohibition information, and charge-discharge-dedicated apparatus information which are stored in the charge-discharge information storage module 503 of the charge-discharge instructing apparatus 500 shown in FIG. 5, various kinds of information relating to migration, multi-stage configuration management, authentication, topology management, connection of different networks, and harmonized synchronization operation which are shown in FIG. 4A and are specific to independent, distributed controls of power converting apparatus 700. For example, where a set of plural power converting apparatus form a group, the conversion information storage module 702 stores, as information relating to multi-stage configuration management, an identifier for identification of a main control apparatus that controls the power converting apparatus belonging to the group. An example operation procedure using the above kinds of information will be described later using a communication sequence diagram. In addition to a case that all of the above kinds of information are stored in the conversion information storage module 702, another case is conceivable in which only a selected part of them are stored therein.

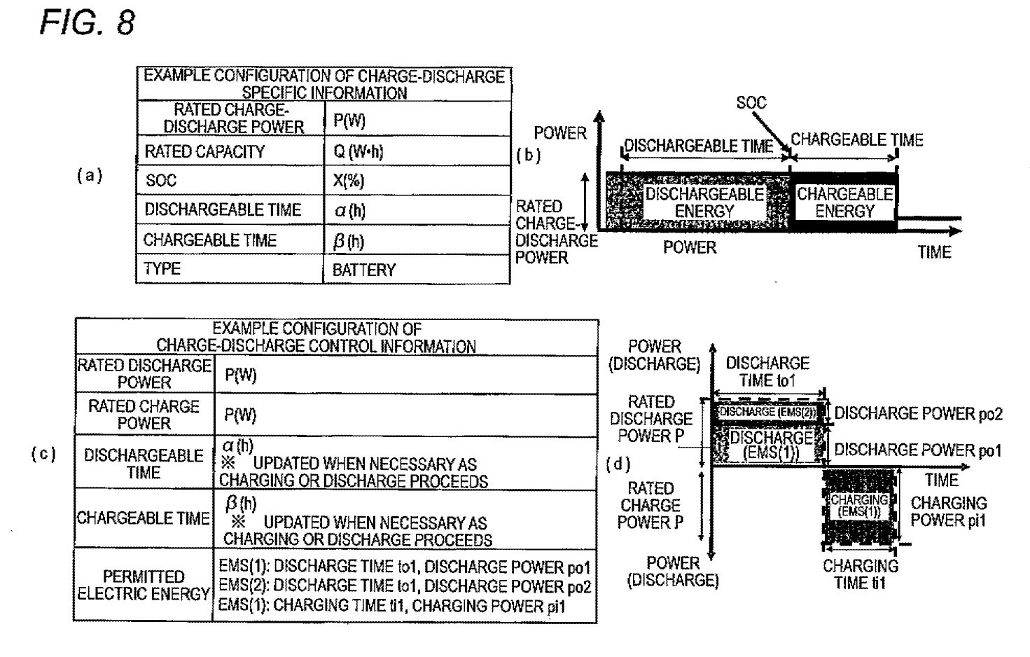

FIGS. 8(a) and 8(c) show example configurations of charge-discharge specific information and charge-discharge control information, respectively, which are stored in the conversion information storage module 702. The conversion information storage module 702 may also store various kinds of information relating to operation items shown in FIG. 4A which are necessary in an independent, distributed control operation and access control information indicating whether or not simultaneous reception of charge-discharge control instructions from plural control instructing apparatus (EMSs or other power converting apparatus) is possible.

The charge-discharge specific information shown in FIG. 8(a) is pieces of information that are specific to a natural energy power generator or a battery and are necessary for a charge-discharge control. In the example of FIG. 8(a), the charge-discharge specific information includes rated charge-discharge power (W), a rated capacity (W·h), a state of charge (SOC; %), and a dischargeable time and a chargeable time which are correlated with the SOC. In the case of the constant current charging method which is a common charging method of batteries, the input/output power (current) of the battery cells of a battery unit (BMU) is kept constant until the SOC (%) reaches a prescribed threshold value. Therefore, as shown in a graph of FIG. 8(b), by acquiring an SOC value from the battery unit, the power converting apparatus 700 can calculate a corresponding chargeable time and dischargeable time (on the horizontal axis of the graph), maximum charge-discharge power (vertical axis of the graph), electric energy values necessary for charging and discharge (products of the power and the chargeable time and the dischargeable time). The constant current charging method has a feature that the current that is necessary for charging is minimized after the SOC has exceeded the prescribed threshold value. In charge-discharge controls, another parameter “current hour” (A·h) or “voltage hour” (V·h) may be used instead of the parameter “electric energy” (W·h). An item “type” is information that indicates a type of an apparatus connected to the power converting apparatus 700 such as a wind power generator, a solar power generator, a battery, or a heat accumulation apparatus and is used for making a judgment relating to a charge-discharge control performed by an EMS or another power converting apparatus. Where the type is a wind power generator or a solar power generator which cannot store electric energy (through charging), the power converting apparatus 700 controls it as an apparatus dedicated to discharge. On the other hand, where a heat accumulation apparatus which cannot discharge power is connected to the power converting apparatus 700, the power converting apparatus 700 controls it as an apparatus dedicated to charging.

The charge-discharge control information shown in FIG. 8(c) is used for recognizing a charge-discharge operation state of an apparatus connected to the power converting apparatus 700. For example, when an apparatus connected to the power converting apparatus 700 is to be controlled in real time to prevent an instantaneous power failure in a power network, it is desirable that the power converting apparatus 700 perform an on-demand operation in which it sends or receives a communication message relating to a charge-discharge control instruction when necessary. On the other hand, when controls are performed at relatively long intervals in a nighttime time slot, it is desirable that the power converting apparatus 700 perform a planned operation in which an operation timing schedule of a charge-discharge control is set. In the example of FIG. 8(c), the charge-discharge control information includes rated discharge power (W), rated charging power (W), a dischargeable time and a chargeable time which are updated when necessary as discharge or charging proceeds, and permitted electric energy values. As shown in FIG. 8(d), the permitted electric energy values mean that the power converting apparatus 700 receive discharge control instructions from EMS1 and EMS2 simultaneously in ranges that are permitted physically in terms of power and time. Although the example of FIG. 8(d) shows permitted electric energy values relating to only EMSs, it goes without saying that where the power converting apparatus 700 and another power converting apparatus operate independently of each other in a distributed manner, information relating to the other power converting apparatus can likewise be included as control details.

As shown in FIGS. 8(a) and 8(b), the power conversion controller 704 has a role of managing charging and discharge of power, that is, input and output of power. In addition to performing a power input/output adjustment according to a charge-discharge control instruction from an EMS or another power converting apparatus, the power conversion controller 704 performs, as ordinary operations, basic functions of an inverter or a converter, that is, makes a judgment as to how to determine power values of an input source and an output destination and voltages (DC/DC, DC/AC, or AC/AC) and a related control.

The communication module 706 has a role of generating communication messages of the various kinds of information shown in FIGS. 8(a) and 8(c) which are necessary for a charge-discharge control and the various kinds of information shown in FIG. 4A which are specific to independent, distributed controls and exchanging such messages with an EMS or another power converting apparatus. The communication module 706 is equipped with, in addition to units for sending and receiving a communication message, a first communication module 7061 and a second communication module 7062 which are communication media. For example, the first communication module 7061 has a wired communication medium such as an optical fiber, a telephone line, or an Ethernet(R) or a wireless communication medium. However, in the embodiment, the communication medium is not limited to a particular one. The power converting apparatus 700 receives, through the first communication module 7061, a communication message transmitted from an EMS or another power converting apparatus. The second communication module 7062 is used for acquiring pieces of specific information (rated capacity, charge-discharge terminal voltages, upper limit temperature, lower limit temperature, maximum charge-discharge currents, rated voltage, etc.) which are specific to a natural energy power generator, a battery, or the like that is connected to the power converting apparatus 700. Where a battery is connected to the power converting apparatus 700, the power converting apparatus 700 acquires, on a regular basis, pieces of state information (SOC, SOH, charge-discharge current, and charge-discharge voltage) which are variable pieces of information occurring when a battery unit (BMU) operates. The second communication module 7062 can be implemented as a communication medium that complies with CAN which is a common interface standard of battery units (BMUs), Ethernet(R), or the like or an electric signal line that is prescribed independently by a vendor who manufactures a battery system. However, the second communication module 7062 is not limited to a particular medium.

In general, self-discharge occurs in battery cells. Therefore, where a battery is connected to the power converting apparatus 700, it is not sufficient to send such information as an SOC and an SOH to an EMS or another power converting apparatus only once; since their values vary every moment, it is desirable to update the values in real time. In the embodiment, as described above, the application range of the power converting apparatus 700 which operates as an inverter or a converter is not limited to controllers (power converting apparatus) connected to a battery. The power converting apparatus 700 can be applied to not only wind power generators, solar power generators, and controllers themselves but also controllers which have a communication function and can communicate with a wind power generator, a solar power generator, a battery, or an EMS. It goes without saying that the application range of the power converting apparatus 700 is not limited to particular kinds of apparatus.

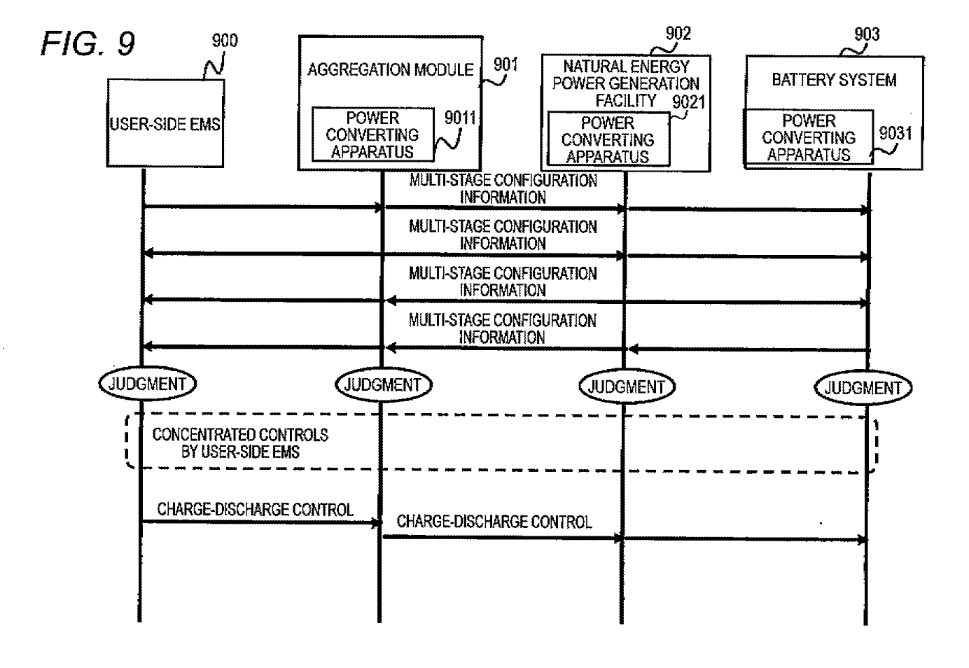

Next, operation sequences of power converting apparatus according to the first embodiment will be described with reference to FIGS. 9-12. These operation sequences particularly relate to initial setting operations of the power converting apparatus.

FIG. 9 is an operation sequence diagram illustrating multi-stage configuration management which is performed at the time of initial setting of power converting apparatus. In the example of FIG. 9, a user-side EMS 900, a aggregation module 901, a natural energy power generation facility 902, and a battery system 903 are provided, which correspond to the user-side EMS 122, the aggregation module 126, the natural energy power generation facility 123, and the battery system 124 shown in FIG. 1, respectively. Although these constituent apparatus are ones provided in user facilities as in the cases shown in FIGS. 3A and 3B, the operation sequence being discussed is not only applicable to user facilities but also likewise applicable to buildings, factories, and systems on power system networks. It is assumed that the user-side EMS 900, the aggregation module 901, the natural energy power generation facility 902, and the battery system 903 are communication-connected or electrically connected to each other. For example, the user-side EMS 900, the aggregation module 901, the natural energy power generation facility 902, and the battery system 903 can exchange communication messages with each other. On the other hand, the aggregation module 901, the natural energy power generation facility 902, and the battery system 903 are electrically connected to each other and hence can output and receive power to and from each other. The aggregation module 901, the natural energy power generation facility 902, and the battery system 903 are equipped with respective power converting apparatus 9011, 9021, and 9031, each of which corresponds to the power converting apparatus 700 shown in FIG. 7.

In the example of FIG. 9, the aggregation module 901, the natural energy power generation facility 902 and the battery system 903 are provided in a home. At the beginning, the user-side EMS 900, the aggregation module 901, the natural energy power generation facility 902, and the battery system 903 exchange pieces of multi-stage configuration information with each other in the form of communication messages. These communication messages may either be communicated by broadcast-type means or be communicated to the individual apparatus by unicast-type means. Each piece of multi-stage configuration information includes identifier information of a group relating to controls by the power converting apparatus 9011, 9021, and 9031 and identifier information of a main control apparatus of the group.

In the example of FIG. 9, the main control apparatus is the user-side EMS 900. After completion of the exchange of the pieces of multi-stage configuration information and judgment processing, the power converting apparatus 9011, 9021, and 9031 are put under the logical control of the user-side EMS 900 and perform charge-discharge controls only according to instructions from the user-side EMS 900. Main control apparatus may be provided in multiple stages. Whereas in the example of FIG. 9 the user-side EMS 900 is the representative apparatus of the group, the aggregation module 901, for example, may be designated as a representative apparatus second to the user-side EMS 900. In this case (see the bottom part of FIG. 9), under this layered structure, the user-side EMS 900 communicates a charge-discharge control instruction to the aggregation module 901, which then communicates the received charge-discharge control instruction to the natural energy power generation facility 902 and the battery system 903.

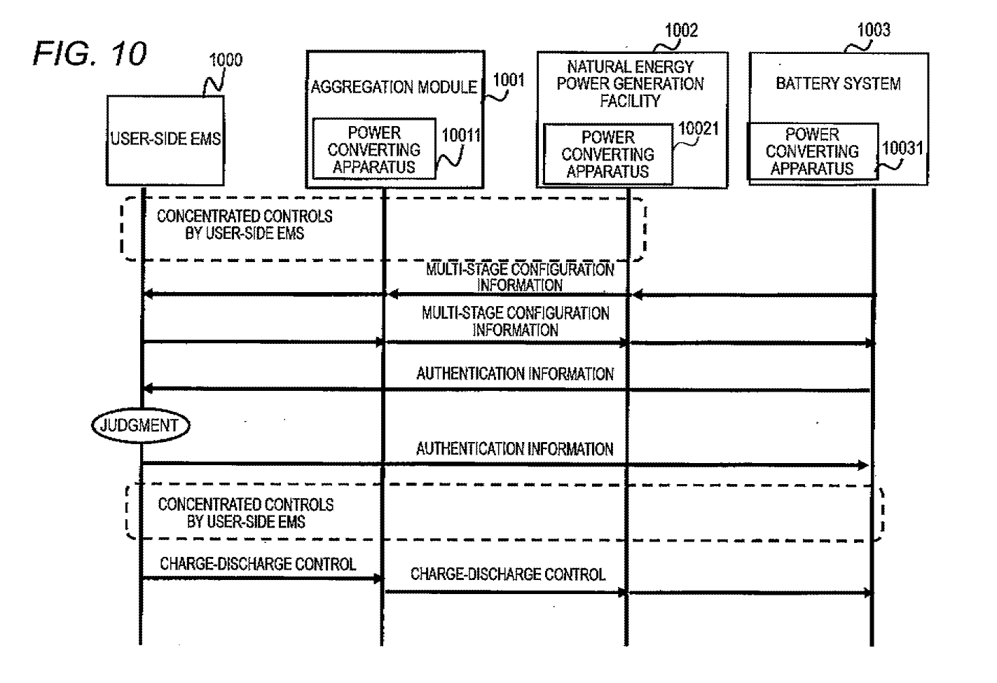

FIG. 10 is an operation sequence diagram illustrating authentication which is performed at the time of initial setting of power converting apparatus. In the example of FIG. 10, a user-side EMS 1000, a aggregation module 1001, a natural energy power generation facility 1002, and a battery system 1003 are provided. Although these constituent apparatus are ones provided in user facilities as in the cases shown in FIGS. 3A and 3B, the operation sequence being discussed is not only applicable to user facilities but also likewise applicable to building, factories, and systems on power system networks. It is assumed that the user-side EMS 1000, the aggregation module 1001, the natural energy power generation facility 1002, and the battery system 1003 are communication-connected or electrically connected to each other. For example, the user-side EMS 1000, the aggregation module 1001, the natural energy power generation facility 1002, and the battery system 1003 can exchange communication messages with each other. On the other hand, the aggregation module 1001, the natural energy power generation facility 1002, and the battery system 1003 are electrically connected to each other and hence can output and receive power to and from each other. The aggregation module 1001, the natural energy power generation facility 1002, and the battery system 1003 are equipped with respective power converting apparatus 1011, 1021, and 1031, each of which corresponds to the power converting apparatus 700 shown in FIG. 7.

The example of FIG. 10 is such that the battery system 1003 has been newly installed in the user facilities. As in the example of FIG. 9, at the beginning, the user-side EMS 1000, the aggregation module 1001, the natural energy power generation facility 1002, and the battery system 1003 exchange pieces of multi-stage configuration information with each other in the form of communication messages. These communication messages may either be communicated by broadcast-type means or be communicated to the individual apparatus by unicast-type means. Each piece of multi-stage configuration information includes identifier information of a group relating to controls by the power converting apparatus 10011, 10021, and 10031 and identifier information of a main control apparatus of the group.

In the example of FIG. 10, the user-side EMS 900 is already made the main control apparatus. After completion of the exchange of the pieces of multi-stage configuration information and judgment processing, the battery system 1003 judges that it has been put under the logical control of the user-side EMS 1000 and can perform a charge-discharge control only according to instructions from the user-side EMS 1000. Then, the battery system 1003 (correctly, the power converting apparatus 10031 provided therein) generates a communication message relating to authentication which is the representative apparatus of the group, and sends the generated communication message to the user-side EMS 1000. As mentioned above, main control apparatus may be managed in multiple stages. Arrangements may be made so that the battery system 1003 communicates its authentication information to the aggregation module 1001 which is a representative apparatus second to the user-side EMS 1000 and the aggregation module 1001 then communicates the received authentication information to the user-side EMS 1000.

Authentication information may be formed by information for identification of an owner of the battery system 1003 which is information relating to access control, an encryption key that is correlated with the identification information, and other information. Using, in addition to the information for authentication as an information processing apparatus, electrical specific information as have been described in the embodiment such as a rated capacity and an output value of the power converting apparatus 10031 makes it possible to increase the reliability when the power converting apparatus 1031 joins the group and cooperates with the other power converting apparatus 1011 and 1021 of the group. In the example shown in the bottom part of FIG. 10, after completion of the authentication procedure, under layered management, the user-side EMS 1000 communicates a charge-discharge control instruction to the aggregation module 1001, which then communicates the received charge-discharge control instruction to the natural energy power generation facility 1002 and the battery system 1003.

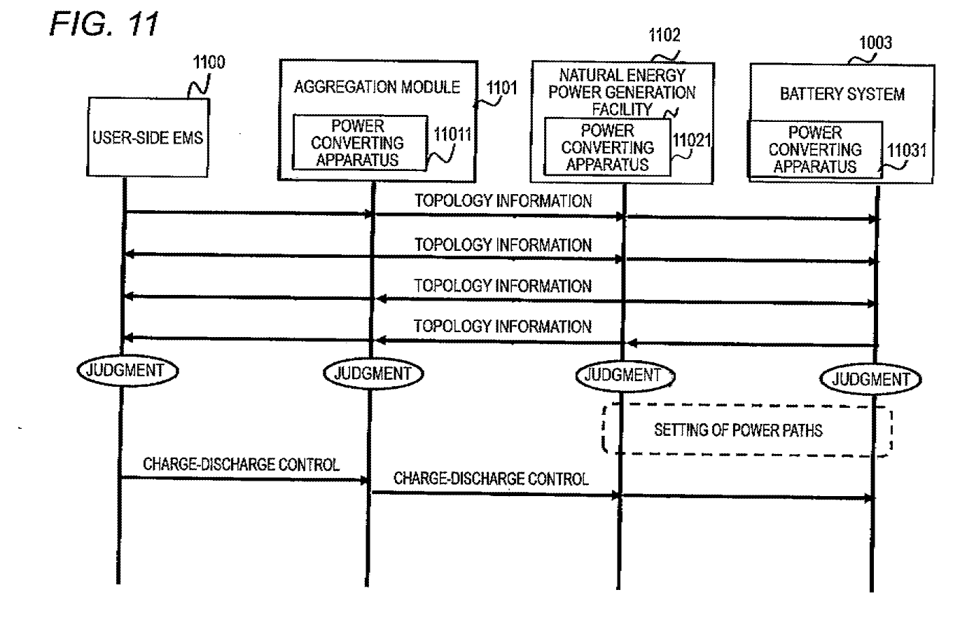

FIG. 11 is an operation sequence diagram illustrating topology detection and setting which are performed at the time of initial setting of power converting apparatus. In the example of FIG. 11, a user-side EMS 1100, a aggregation module 1101, a natural energy power generation facility 1102, and a battery system 1103 are provided. Although these constituent apparatus are ones provided in user facilities as in the cases shown in FIGS. 3A and 3B, the operation sequence being discussed is not only applicable to user facilities but also likewise applicable to buildings, factories, and systems on power system networks. It is assumed that the user-side EMS 1100, the aggregation module 1101, the natural energy power generation facility 1102, and the battery system 1103 are communication-connected or electrically connected to each other. For example, the user-side EMS 1100, the aggregation module 1101, the natural energy power generation facility 1102, and the battery system 1103 can exchange communication messages with each other. On the other hand, the aggregation module 1101, the natural energy power generation facility 1102, and the battery system 1103 are electrically connected to each other and hence can output and receive power to and from each other. The aggregation module 1101, the natural energy power generation facility 1102, and the battery system 1103 are equipped with respective power converting apparatus 11011, 11021, and 11031, each of which corresponds to the power converting apparatus 700 shown in FIG. 7.

In the example of FIG. 11, the aggregation module 1101, the natural energy power generation facility 1102 and the battery system 1103 are provided in a home. At the beginning, the user-side EMS 1100, the aggregation module 1101, the natural energy power generation facility 1102, and the battery system 1103 exchange pieces of information relating to topology management with each other in the form of communication messages. These communication messages may either be communicated by broadcast-type means or be communicated to the individual apparatus by unicast-type means. Each piece of information relating to topology management is information indicating paths along which the power converting apparatus receives power from what power converting apparatus and outputs power to what power converting apparatus. In the example of FIG. 11, it is specified that power to charge the battery system 1103 should be supplied only from the natural energy power generation facility 1102 which belongs to the same group. Performing topology detection and setting in this manner makes it possible to lower the cost in the case where cost management is made by correlating cost information such as prices with power information.

In the example shown in the bottom part of FIG. 11, as in the examples of FIGS. 9 and 10, under a layered structure, the user-side EMS 1100 communicates a charge-discharge control instruction to the aggregation module 1101, which then communicates the received charge-discharge control instruction to the natural energy power generation facility 1102 and the battery system 1103.

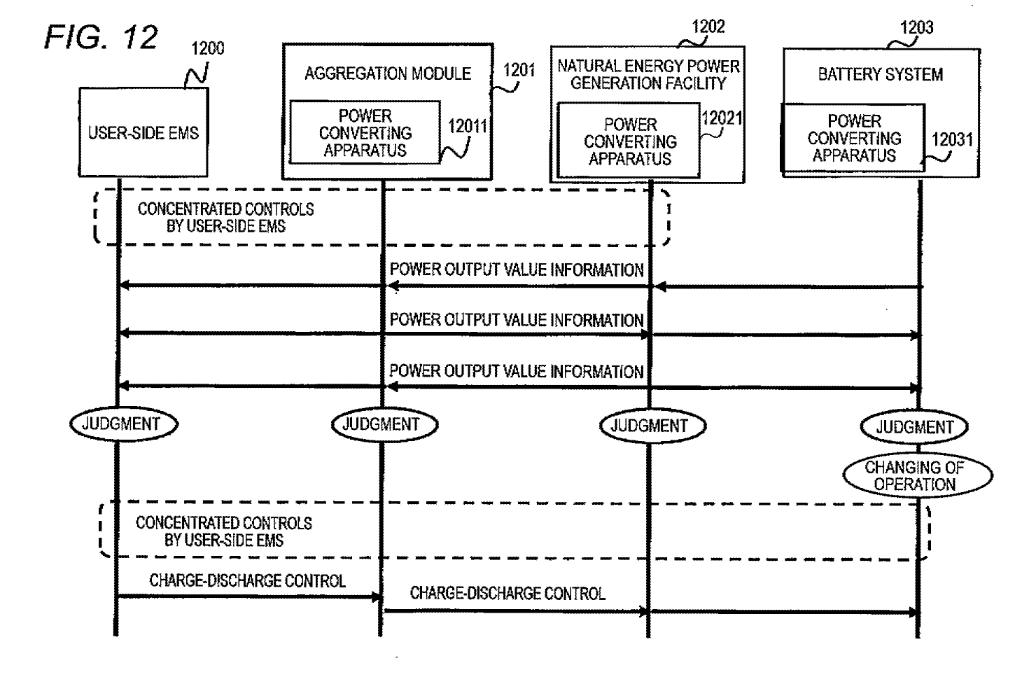

FIG. 12 is an operation sequence diagram illustrating a harmonized synchronization operation which is performed at the time of initial setting of power converting apparatus. In the example of FIG. 12, a user-side EMS 1200, a aggregation module 1201, a natural energy power generation facility 1202, and a battery system 1203 are provided. Although these constituent apparatus are ones provided in user facilities as in the cases shown in FIGS. 3A and 3B, the operation sequence being discussed is not only applicable to user facilities but also likewise applicable to buildings, factories, and systems on power system networks. It is assumed that the user-side EMS 1200, the aggregation module 1201, the natural energy power generation facility 1202, and the battery system 1203 are communication-connected or electrically connected to each other. For example, the user-side EMS 1200, the aggregation module 1201, the natural energy power generation facility 1202, and the battery system 1203 can exchange communication messages with each other. On the other hand, the aggregation module 1201, the natural energy power generation facility 1202, and the battery system 1203 are electrically connected to each other and hence can output and receive power to and from each other. The aggregation module 1201, the natural energy power generation facility 1202, and the battery system 1203 are equipped with respective power converting apparatus 12011, 12021, and 12031, each of which corresponds to the power converting apparatus 700 shown in FIG. 7.

The example of FIG. 12 is such that the battery system 1203 has been newly installed in the user facilities. As in the above-described examples, communication messages relating to multi-stage configuration intimation may either be exchanged or not be exchanged in advance. Even if it is desired to install the battery system 1203 incorporating the power converting apparatus 12031 and use power supplied from it immediately after the installation, the start of operation may be delayed by a time taken by exchange of communication messages. However, if information exchange with the other apparatus 1200, 1201, and 1202 is not performed in advance, the power converting apparatus 12011, 12012, and 12013 operate without taking into consideration the fact that the voltage and the frequency vary depending on the country or area where the power system is going to be used, possibly resulting in reduction in its reliability. For example, assume that in the example of FIG. 12 the battery system 1203 is to operate at 60 Hz and the aggregation module 1201 and the natural energy power generation facility 1202 are already in operation at 50 Hz. One measure to be taken in this case is to establish synchronization with the other, already existing power converting apparatus 12011 and 12012 by exchanging communication messages relating to operation states as pieces of power output value information or performing electric measurements directly. These communication messages may either be communicated by broadcast-type means or be communicated to the individual apparatus by unicast-type means.

In the example of FIG. 12, the battery system 1203 (correctly, the power converting apparatus 12031 provided therein) detects that its power output value is different from power output values of the other power converting apparatus 12011 and 12021 and changes its operation state and output power state. Although omitted in FIG. 12, as in the above-described examples, a main control apparatus of the group may be determined by exchanging communication messages relating to multi-stage configuration. In the example shown in the bottom part of FIG. 12, the user-side EMS 1200 which is a main control apparatus of the group communicates a charge-discharge control instruction to the aggregation module 1201, which then communicates the received charge-discharge control instruction to the natural energy power generation facility 1202 and the battery system 1203.

As described above, the power converting apparatus 700 according to the first embodiment has the function of operating so as to adapt to a variation in system configuration when, for example, the main control apparatus for controlling plural power converting apparatus has been changed or a new power converting apparatus has been connected to a system including plural power converting apparatus. This provides an advantage that the charge-discharge power throughput can be maintained while the flexibility of installation places and the reliability are kept high.

For example, the power converting apparatus 700 can be implemented using a general-purpose computer as basic hardware. That is, the power receivers 701, the power converter 703, the power output modules 705, the conversion information storage module 702, the power conversion controller 704, and the communication module 706 can be realized by causing a processor of the computer to run programs. The programs may either be preinstalled in the computer or be stored in a storage medium such as a CD-ROM or be delivered over a network and installed in the computer when necessary. The conversion information storage module 702 can be implemented using, as appropriate, a memory or a hard disk drive that is incorporated in or externally connected to the computer or a storage medium such as a CD-R, CD-RW, a DVD-RAM, or a DVD-R.

### Embodiment 2

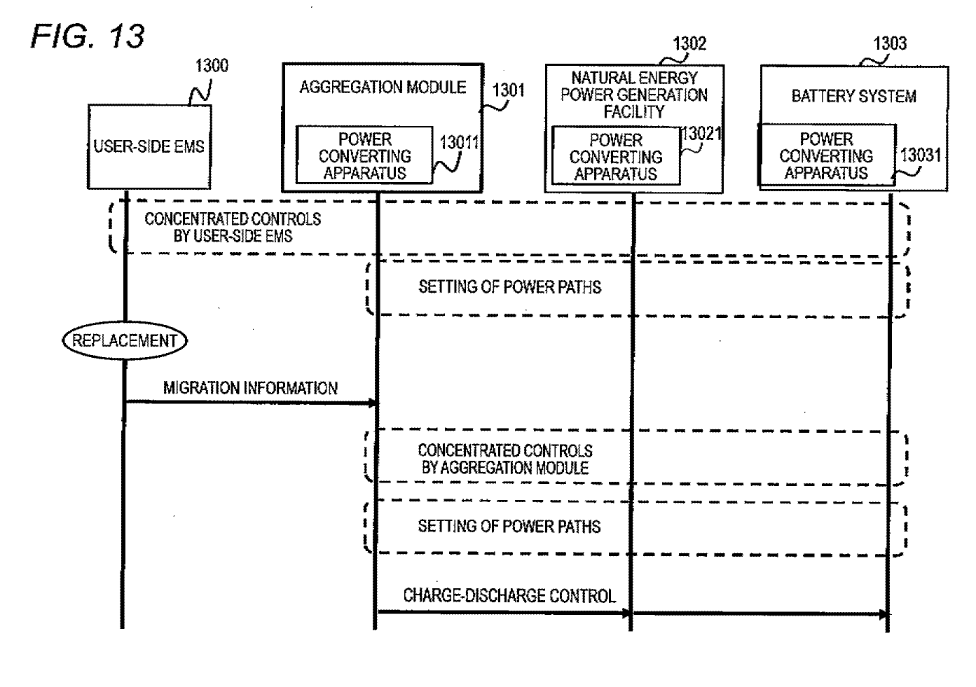

A second embodiment of the invention relates to occurrence of a failure and a replacement of an apparatus in a power system including power converting apparatus. Operation sequences of power converting apparatus according to the second embodiment will be described with reference to FIGS. 13-16. These operation sequences particularly relate to initial setting operations of the power converting apparatus.

FIG. 13 is an operation sequence diagram illustrating migration which is performed at the time of changing of operation of power converting apparatus. In the example of FIG. 13, a user-side EMS 1300, a aggregation module 1301, a natural energy power generation facility 1302, and a battery system 1303 are provided. Although these constituent apparatus are ones provided in user facilities as in the cases shown in FIGS. 3A and 3B, the operation sequence being discussed is not only applicable to user facilities but also likewise applicable to buildings, factories, and systems on power system networks. It is assumed that the user-side EMS 1300, the aggregation module 1301, the natural energy power generation facility 1302, and the battery system 1303 are communication-connected or electrically connected to each other. For example, the user-side EMS 1300, the aggregation module 1301, the natural energy power generation facility 1302, and the battery system 1303 can exchange communication messages with each other. On the other hand, the aggregation module 1301, the natural energy power generation facility 1302, and the battery system 1303 are electrically connected to each other and hence can output and receive power to and from each other. The aggregation module 1301, the natural energy power generation facility 1302, and the battery system 1303 are equipped with respective power converting apparatus 13011, 13021, and 13031, each of which corresponds to the power converting apparatus 700 shown in FIG. 7.

In the example of FIG. 13, it is assumed that the aggregation module 1301, the natural energy power generation facility 1302, and the battery system 1303 have been controlled by the user-side EMS 1300 in a concentrated manner and power paths have been set between the aggregation module 1301, the natural energy power generation facility 1302, and the battery system 1303. If in this state the user-side EMS 1300 is replaced or a nonfatal abnormality is detected, the power system of the group is maintained by informing the aggregation module 1301 of the state information managed by the user-side EMS 1300 (migration). It is assumed that migration information consists of various kinds of information described above such as information of multi-stage configuration and information of topology management.

In the example of FIG. 13, after transmission of a communication message relating to migration information, the aggregation module 1301 is made a new main control apparatus of the group and comes to give charge-discharge control instructions to the natural energy power generation facility 1302 and the battery system 1303. Communication messages may either be communicated by broadcast-type means or be communicated to the individual apparatus by unicast-type means. Multi-stage configuration information includes identifier information of the group relating to controls by the power converting apparatus 13011, 13021, and 13031 and identifier information of the main control apparatus of the group. Information relating to topology management is information indicating paths along which the power converting apparatus receives power from what power converting apparatus and outputs power to what power converting apparatus.

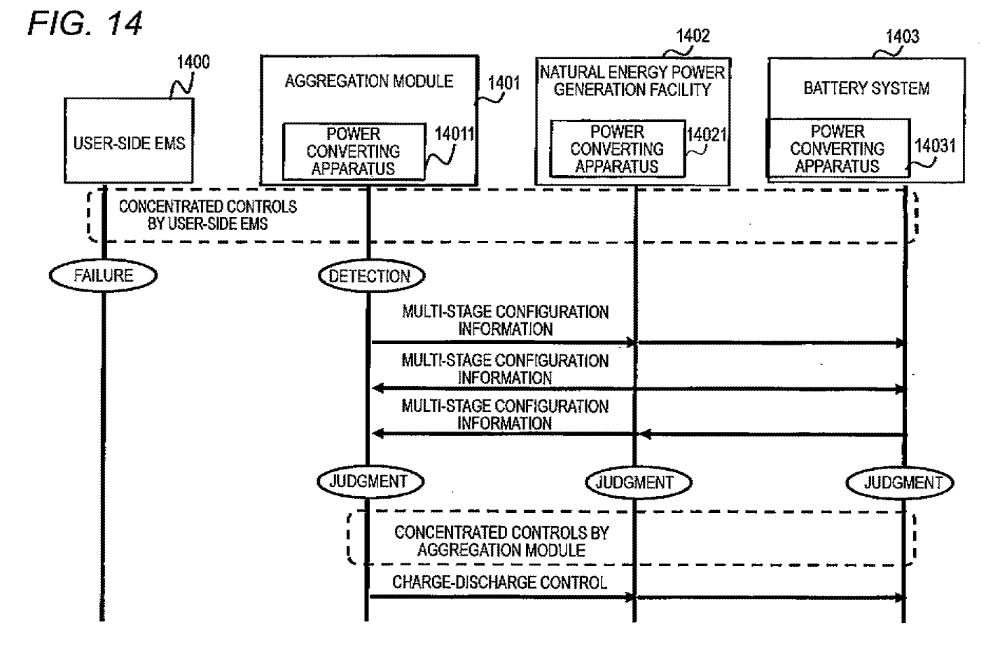

FIG. 14 is an operation sequence diagram illustrating multi-stage configuration management which is performed at the time of changing of operation of power converting apparatus. In the example of FIG. 14, a user-side EMS 1400, a aggregation module 1401, a natural energy power generation facility 1402, and a battery system 1403 are provided. Although these constituent apparatus are ones provided in user facilities as in the cases shown in FIGS. 3A and 3B, the operation sequence being discussed is not only applicable to user facilities but also likewise applicable to buildings, factories, and systems on power system networks. It is assumed that the user-side EMS 1400, the aggregation module 1401, the natural energy power generation facility 1402, and the battery system 1403 are communication-connected or electrically connected to each other. For example, the user-side EMS 1400, the aggregation module 1401, the natural energy power generation facility 1402, and the battery system 1403 can exchange communication messages with each other. On the other hand, the aggregation module 1401, the natural energy power generation facility 1402, and the battery system 1403 are electrically connected to each other and hence can output and receive power to and from each other. The aggregation module 1401, the natural energy power generation facility 1402, and the battery system 1403 are equipped with respective power converting apparatus 14011, 14021, and 14031, each of which corresponds to the power converting apparatus 700 shown in FIG. 7.

The example of FIG. 14 is directed to a case that a failure occurs in the user-side EMS 1400 in a state that the user-side EMS 1400, the aggregation module 1401, the natural energy power generation facility 1402, and the battery system 1403 are installed. If an abnormality such as disconnection of the communication connection to the user-side EMS 1400 which is a main control apparatus of the group is detected, the aggregation module 1401, the natural energy power generation facility 1402, and the battery system 1403 exchange pieces of multi-stage configuration information in the form of communication messages. These communication messages may either be communicated by broadcast-type means or be communicated to the individual apparatus by unicast-type means. Multi-stage configuration information includes identifier information of the group relating to controls by the power converting apparatus 14011, 14021, and 14031 and identifier information of the main control apparatus of the group. In the example of FIG. 14, the main control apparatus is changed from the user-side EMS 1400 to the aggregation module 1401. After completion of the exchange of the pieces of multi-stage configuration information and judgment processing, the power converting apparatus 14011, 14021, and 14031 are put under the logical control of the aggregation module 1401 and perform charge-discharge controls only according to instructions from the aggregation module 1401. Main control apparatus may be provided in multiple stages. For example, the battery system 1403 may be designated as a representative apparatus second to the aggregation module 1401.

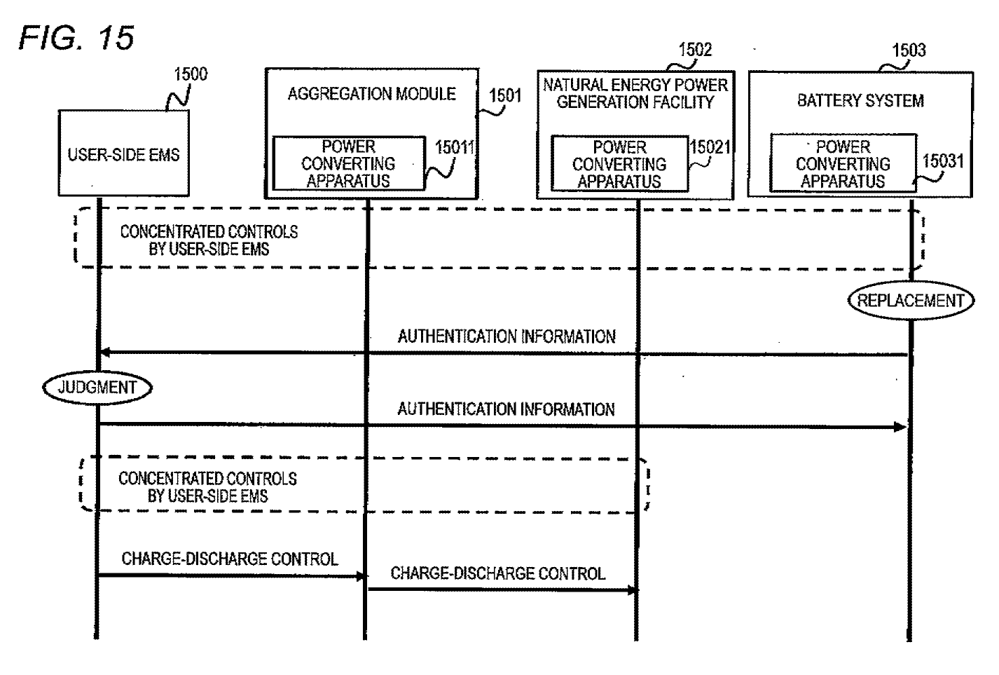

FIG. 15 is an operation sequence diagram illustrating authentication which is performed at the time of changing of operation of power converting apparatus. In the example of FIG. 15, a user-side EMS 1500, a aggregation module 1501, a natural energy power generation facility 1502, and a battery system 1503 are provided. Although these constituent apparatus are ones provided in user facilities as in the cases shown in FIGS. 3A and 3B, the operation sequence being discussed is not only applicable to user facilities but also likewise applicable to buildings, factories, and systems on power system networks. It is assumed that the user-side EMS 1500, the aggregation module 1501, the natural energy power generation facility 1502, and the battery system 1503 are communication-connected or electrically connected to each other. For example, the user-side EMS 1500, the aggregation module 1501, the natural energy power generation facility 1502, and the battery system 1503 can exchange communication messages with each other. On the other hand, the aggregation module 1501, the natural energy power generation facility 1502, and the battery system 1503 are electrically connected to each other and hence can output and receive power to and from each other. The aggregation module 1501, the natural energy power generation facility 1502, and the battery system 1503 are equipped with respective power converting apparatus 15011, 15021, and 15031, each of which corresponds to the power converting apparatus 700 shown in FIG. 7.

The example of FIG. 15 is directed to a case that the battery system 1503 which is installed in a home is removed for replacement. Communication messages for canceling the authentication-completed state are sent. These communication messages may either be communicated by broadcast-type means or be communicated to the individual apparatus by unicast-type means. The battery system 1503 (correctly, the power converting apparatus 15031 provided therein) generates a communication message relating to authentication and sends it to the user-side EMS 1500 which is the representative apparatus of the group. As described above, main control apparatus may be managed in multiple stages. Arrangements may be made so that the battery system 1503 communicates its authentication information to the aggregation module 1501 which is a representative apparatus second to the user-side EMS 1500 and the aggregation module 1501 then communicates the received authentication information to the user-side EMS 1500. Authentication information may be formed by information for identification of an owner of the battery system 1503 which is information relating to access control, an encryption key that is correlated with the identification information, and other information. Unlike in the case of establishing an authenticated state, as long as the identification information is used, electrical specific information as described in the first embodiment such as a rated capacity and an output value of the power converting apparatus 15031 can be omitted. In the example shown in the bottom part of FIG. 15, after completion of the authentication canceling procedure, the user-side EMS 1500 communicates a charge-discharge control instruction to the aggregation module 1501, which then communicates the received charge-discharge control instruction to only the natural energy power generation facility 1502 (not to the battery system 1503).

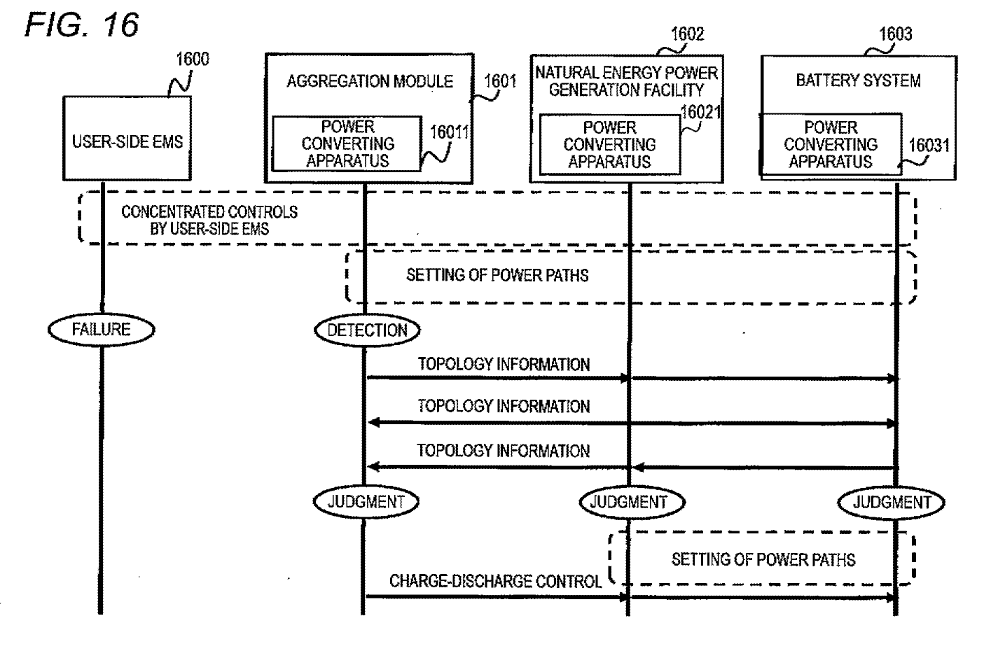

FIG. 16 is an operation sequence diagram illustrating topology detection and setting which are performed at the time of changing of operation of power converting apparatus. In the example of FIG. 16, a user-side EMS 1600, a aggregation module 1601, a natural energy power generation facility 1602, and a battery system 1603 are provided. Although these constituent apparatus are ones provided in user facilities as in the cases shown in FIGS. 3A and 3B, the operation sequence being discussed is not only applicable to user facilities but also likewise applicable to buildings, factories, and systems on power system networks. It is assumed that the user-side EMS 1600, the aggregation module 1601, the natural energy power generation facility 1602, and the battery system 1603 are communication-connected or electrically connected to each other. For example, the user-side EMS 1600, the aggregation module 1601, the natural energy power generation facility 1602, and the battery system 1603 can exchange communication messages with each other. On the other hand, the aggregation module 1601, the natural energy power generation facility 1602, and the battery system 1603 are electrically connected to each other and hence can output and receive power to and from each other. The aggregation module 1601, the natural energy power generation facility 1602, and the battery system 1603 are equipped with respective power converting apparatus 16011, 16021, and 16031, each of which corresponds to the power converting apparatus 700 shown in FIG. 7.

In the example of FIG. 16, it is assumed that a logical group relating to control rights for the user-side EMS 1600, the aggregation module 1601, the natural energy power generation facility 1602, and the battery system 1603 and power paths relating to the aggregation module 1601, the natural energy power generation facility 1602, and the battery system 1603 are already established. If occurrence of a failure in the user-side EMS 1600 is detected in this state, the other apparatus, that is, the aggregation module 1601, the natural energy power generation facility 1602, and the battery system 1603 exchange pieces of information relating to topology management in the form of communication messages. These communication messages may either be communicated by broadcast-type means or be communicated to the individual apparatus by unicast-type means. Each piece of information relating to topology management is information indicating paths along which the power converting apparatus receives power from what power converting apparatus and outputs power to what power converting apparatus. In the example of FIG. 16, at the beginning, the battery system 1603 is charged by power that is supplied from a power system network via the aggregation module 1601. As a result of detection of a state change and re-setting, it is specified that the battery system 1603 should be charged only by the natural energy power generation facility 1602 which belongs to the same group. The above topology detection and setting enables cost reduction in the case where a power value is correlated with cost information such as a price.

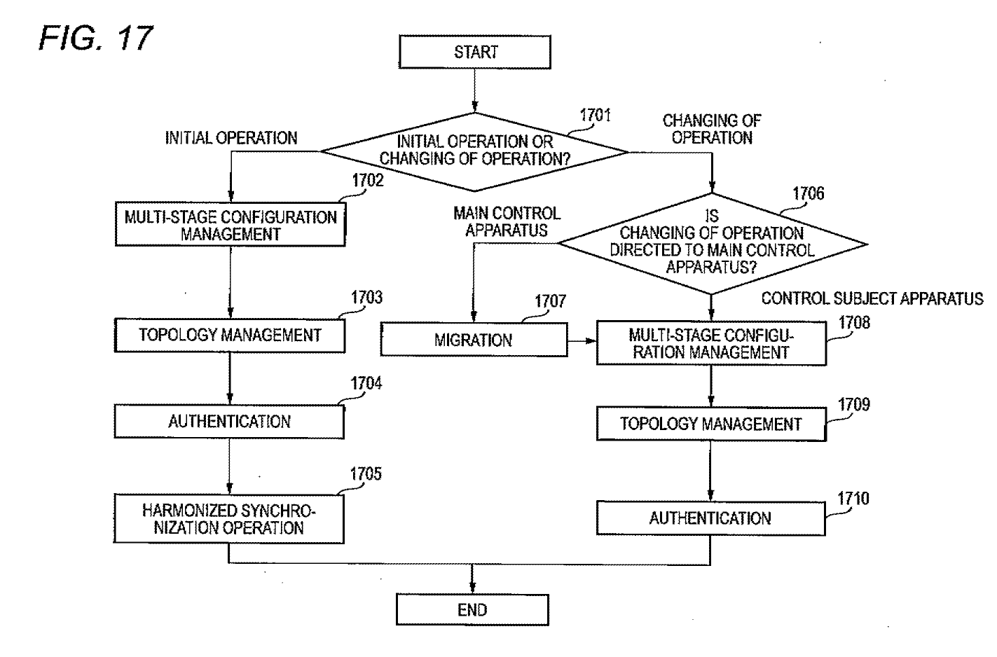

FIG. 17 is a flowchart showing how power converting apparatus according to the embodiments operate. The example operations performed at the time of initial setting and the example operations performed at the time of changing of operation have been described in the first embodiment and the second embodiment, respectively. Basically, communication messages exchanged between the apparatus and operation details are in large part common to the first and second embodiments. The order of execution of the multi-stage configuration management, the topology management, and the authentication is not limited to that shown in FIG. 17 and can be changed as appropriate.

The above-described embodiments provide an advantage that since power converting apparatus each of which is connected to a distribution type power source such as a solar power generator or a battery exchange communication messages according to their operation states, the charge-discharge power throughput can be kept high while necessary flexibility of installation places is secured.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. A power converting apparatus, comprising:
a power receiver configured to receive a first power from a first apparatus;
a power converter configured to convert the first power into a second power that can be received by a second apparatus;
a power output module configured to output the second power to the second apparatus;
a communication module configured to receive a first identifier of a main controller, wherein the main controller belongs to a first group which is composed of apparatuses including the power converting apparatus and the main controller is configured to send a first power output instruction to at least one of the apparatuses belonging to the first group;
a conversion information storage module configured to store the first identifier; and
a power conversion controller configured to cause the power converter to convert the first power into the second power, when the communication module receives the first power output instruction from the main controller identified by the first identifier.

2. The apparatus of claim 1, wherein
if the main controller is the power converting apparatus, the communication module is configured to send a second identifier for identifying the power converting apparatus to the apparatuses belonging to the first group and to send a second power output instruction to at least one of the apparatuses belonging to the first group.

3. The apparatus of claim 1, wherein
when the power conversion controller receives a message for instructing the power converting apparatus to become the main controller through the communication module, the power conversion controller causes the communication module to send a second power output instruction to the apparatuses belonging to the first group.

4. The apparatus of claim 2, wherein
when the main controller is changed from the power converting apparatus to another power converting apparatus belonging to the first group, the power conversion controller causes the communication module to send the another converting apparatus a message for instructing the another converting apparatus to become the main controller.

5. The apparatus of claim 2, wherein
if the main controller is the power converting apparatus, and the communication module receives, from a first power converting apparatus belonging to the first group, an authentication message that requests authentication for the first power converting apparatus to exchange a power with power converting apparatuses belonging to the first group, the power conversion controller determines whether to permit the first power converting apparatus to exchange a power with the power converting apparatuses belonging to the first group.

6. The apparatus of claim 2, wherein the power conversion controller is configured to control the first apparatus and the second apparatus.

7. The apparatus of claim 2, wherein the power conversion controller is configured to send information for identifying the first apparatus and information for identifying the second apparatus to power converting apparatuses belonging to the first group.

8. The apparatus of claim 1, wherein
the power conversion controller is configured to detect a frequency of power that is output from the other power converting apparatus belonging to the first group, and synchronize a frequency of power that is output from the power converting apparatus with the frequency of the power that is output from the other power converting apparatus.

9. A non-transitory computer-readable medium storing a program for causing a computer to perform an operation comprising:
(a) receiving a first power from a first apparatus;
(b) converting the first power into a second power that can be received by a second apparatus;
(c) outputting the second power to the second apparatus;
(d) receiving a first identifier of a the main controller, wherein the main controller belongs to a first group which is composed of apparatuses including the power converting apparatus and the main controller is configured to send a first power output instruction to at least one of apparatuses belonging to the first group; and
(e) converting the first power into the second power, when receiving the first power output instruction from the main controller identified by the first identifier.
